(19) United States
(12) Patent Application Publication
(10) Pub. No.: US 2026/0226739 A1
(43) Pub. Date: Aug. 6, 2026

(54) METHOD FOR JOINING LOAD-BEARING WOODEN STRUCTURAL PANELS

(71) Applicant: Timber Structures 3.0 AG, Thun (CH)

(72) Inventor: Stefan Zöllig, Thun (CH)

(73) Assignee: Timber Structures 3.0 AG, Thun (CH)

(21) Appl. No.: 19/147,100

(22) PCT Filed: Feb. 6, 2024
(86) PCT No.: PCT/IB2024/051059

§ 371 Date: Jul. 10, 2025

(30) Foreign Application Priority Data
Feb. 14, 2023 (CH) CH000130/2023

(51) Int. Cl. E04C 2/12; B32B 21/04; B32B 37/12; E04B 5/02

(52) U.S. Cl. CPC E04C 2/12; B32B 21/042; B32B 37/12; E04C 2/50; B32B 2037/1253; B32B 2250/02; B32B 2419/00

(57) ABSTRACT

The invention relates to a method for producing a composite timber construction panel for a building structure, comprising providing a first biaxially load-bearing timber construction panel (1) having a first side surface (11), coating the first side surface (11) of the first timber construction panel (1) with a stable adhesive (3), arranging a second biaxially load-bearing timber construction panel (2) having a first side surface (21), so that the first side surface (21) of the second timber construction panel abuts against the adhesive-coated first side surface (11) of the first timber construction panel, whereby an adhesive layer (3) covering both side surfaces (11, 21) is formed, and curing the adhesive layer (3) without the application of pressure. At least one of the two side surfaces (11, 21) has a spacer element (4) which is arranged along at least a part of the periphery of the first side surface (11, 21) and which defines a shallow cavity. The composite timber construction panel may be produced at a first location and assembled, preferably glued, at a second location to form a final product. The method is particularly suitable for the production of load-bearing building ceilings.

### TECHNICAL AREA

The invention relates to a manufacturing process for composite timber construction panels suitable for use in timber construction, for example in load-bearing floor ceilings.

### STAT OF THE ART

In contrast to concrete floors or concrete ceilings, which are poured on site from liquid concrete, the use of wooden ceilings in timber construction still poses logistical problems.

It is known that timber components, in particular timber panels, can be bonded to load-bearing floor ceilings which do not require any additional metal or concrete fixings.

In WO2014173633, a manufacturing method was described for glued large-area timber components that can be used as load-bearing components in timber construction. However, timber construction ceilings, or parts of these ceilings, are predominantly bonded on site at the construction-site, since, as a result of their large surface areas, it is not possible to deliver complete prefabricated floor ceilings to the construction site. At the construction site, the delivered panels are manually bonded together via a joint, i.e. a shallow cavity, with an adhesive to form a large-area structure, such as a ceiling.

The dimensions of available means of transportation limit the size of the timber construction panels or composite timber construction panels that can be prefabricated in industrial facilities.

CH20220001228 describes a method of making a composite timber construction panel for building structures in which a first timber construction panel is joined to a second timber construction panel with a two-component adhesive via a recess in a lateral side of the panel. The timber construction panels can be mechanically cast with adhesive so that an intermediate product for a timber construction ceiling can be produced at an industrial production site. This intermediate product can then be assembled on site to form a larger load-bearing structure, such as a ceiling. The process makes a significant contribution to reducing the time and labor required to complete a large timber construction panel on the construction site.

However, casting the timber panels with adhesive, both mechanically and manually, has certain disadvantages. On the one hand, the adhesive filled into the grouting joint should have a low viscosity, i.e. be as fluid as possible, in order to reduce the risk of air bubbles being trapped in the adhesive layer. Trapped air bubbles reduce the quality of the bonded joint and therefore the load-bearing capacity of the composite timber construction panel.

On the other hand, the risk of a liquid adhesive with low viscosity leaking out of the joint is significantly increased. Leakage can in turn lead to air entrapment in the joint and/or incomplete filling of the joint, which weakens the adhesive bond. Errors in the filling of the joint can occur in both automated and manual manufacturing processes. The resulting reduction in quality in a load-bearing timber construction end product can have devastating effects.

Particularly precise work as well as checks to ensure that no air bubbles are trapped, that the adhesive joint is completely filled with adhesive and that the adhesive filled in does not leak are therefore crucial.

### SHORT DESCRIPTION OF THE INVENTION

It is an object of the present invention to provide a method for providing composite timber construction panels which overcomes the disadvantages of known methods.

It is an object of the present invention to provide a method by means of which composite timber construction panels of reproducibly good quality can be fabricated. In particular, the quality of the joint should be reproducible, so that variations in quality between individual composite timber construction panels are reduced or avoided.

It is a further object of the present invention to provide a method of assembling composite timber construction panels which can be carried out at least partially by machine.

It is also an object of the present invention to provide an alternative fabrication method for composite timber construction panels.

According to the invention, one or more of these objectives are achieved by a method according to the independent first claim. Further advantageous embodiments of the method are provided in the dependent claims.

Specifically, one or more of these objectives are achieved by a method for producing a composite timber construction panel in which a first side surface of a first, biaxially load-bearing timber construction panel is coated with a stable adhesive, preferably a two-component adhesive. For this purpose, the adhesive is preferably distributed essentially over the entire side surface. Essentially distributed over the entire side surface means that the side surface is either completely coated with adhesive or that only a narrow edge area, which is narrower than three times or twice the layer thickness of the adhesive coating, or narrower than the average layer thickness of the adhesive coating, is left free. If a spacer element is provided in this area between the first and the second timber construction panel in the edge area, the free edge area may be the area contacting the spacer element plus no more than three times or twice the layer thickness, or no more than the average layer thickness of the adhesive coating.

Preferably, the distributed adhesive forms a layer of homogeneous thickness.

The stable adhesive may be a two-or multi-component adhesive, for example a two-or multi-component adhesive based on polyurethane (PUR) or epoxy resin.

The first side surface of the first timber construction panel may be mechanically coated with a stable adhesive, for example using a slotted nozzle.

The first side surface of the first timber construction panel can also be coated manually with a stable adhesive.

In a next step, a second biaxial load-bearing timber construction panel with a first side surface is arranged in such a way that the first side surface of this timber construction panel abuts against the adhesive-coated first side surface of the first timber construction panel, thereby forming an adhesive layer which covers the first side surfaces of the two timber construction panels. Preferably, the two first side surfaces are completely covered with adhesive.

The fact that the first side surface of the second timber construction panel is joined to the first side of the first timber construction panel, which is already coated with a stable adhesive, prevents the formation of air pockets or air bubbles. In addition, leakage of the adhesive from the joint is reduced or completely avoided by using a stable adhesive. The use of a stable adhesive is not possible for casting the panels over a joint, as this would lead to considerable air pockets.

Accordingly, the method of the present invention offers the advantage of reducing the risk of insufficient formation of a joint-filling adhesive layer between the bonded timber panels. It is particularly advantageous that air inclusions or air pockets in the adhesive layer can be substantially reduced or completely avoided by means of this method, whereby the quality of the joint is improved. As the risk of air pockets is reduced, variation in the quality of the bond between different composite timber panels is prevented, so that this process not only provides improved joints, but also composite timber panels with reproducible quality.

This process enables the timber panel to be glued under constant and controlled conditions. It is therefore particularly suitable for automation. Compared to the conventional grouting process, the process of this invention is less complex, especially with regard to the application of adhesive. In addition, the bonding of the timber panels is faster, as the process of grouting of joints is relatively time-consuming.

In one embodiment, the first side of the second timber construction panel has one or more spacer elements. A spacer element is used to determine a minimum distance between the panels. The spacer elements are preferably made of the same material as the second timber construction panel. Preferably, the at least one spacer element is formed in one piece with the second timber construction panel on the first side surface. Spacer elements that are integral components of the timber construction panel offer the advantage that no additional work step is required to attach the spacer elements. Furthermore, gaps which may for example be caused by inaccurate attachment of spacer elements can be avoided.

At least one of the spacer elements is arranged along at least a part of the periphery of the first side surface of the second timber panel and defines a joint. A joint is a shallow cavity that is formed between the first side surfaces of the two timber construction panels arranged relative to each other and that can be or is filled with adhesive.

One or more spacer elements may be arranged along the periphery of the first side surface in such a way as to delimit a flat cavity along at least three sides.

One or more spacer elements may be distributed over the surface of the first side of the second timber panel.

One or more spacer elements may be arranged to delimit one or more open or closed joint pockets. A closed joint pocket is a joint that is completely bounded by one or more spacer elements. An open joint pocket is a joint pocket that is open to the outside in at least one section. An open joint pocket can, for example, be open at the top if the timber panels are positioned on the floor for bonding.

The two timber panels are preferably arranged in such a way that the minimum distance between the panels is 0.1 mm, 0.5 mm, 1 mm, 2 mm, 3 mm or 4 mm. However, the minimum distance may also be considerably greater, for example 20 mm. The distance that forms the joint between the two panels is filled by the adhesive coating of the first timber panel.

The timber panels are arranged in relation to each other to distribute the adhesive layer over the entire joint or over the entire distance. To ensure an even distribution of the adhesive over both side surfaces to be bonded, the panels are pushed together until the adhesive completely covers the surfaces to be bonded. In particular, the adhesive should also be distributed over the edge area of the first timber panel or up to the spacer element bordering the joint. In this arrangement, the stable adhesive completely covers the first side surface of the first timber construction panel. The first surface of the first timber construction panel is completely coated with adhesive, at least in the sections that do not form spacer elements or are covered by them.

Unless pre-treated, the structure of the side surfaces is naturally somewhat rough. To ensure that all unevenness in the side surfaces is completely covered, a light pressure can be applied when the two panels are arranged in relation to each other. However, it is important that no pressure is applied during the curing of the adhesive that could reduce the distance between the timber panels. The position of the arranged panels therefore remains unchanged during the curing of the adhesive. In other words, the adhesive is cured without applying any pressure.

The first side surface of the first timber panel may be pre-treated in order to compensate for natural unevenness in the side surfaces of the timber panels and to thus further improve the quality of the joint. The side surface may be pre-treated with adhesive before it is coated. The side surface may be spackled, for example. Alternatively or additionally, the first side surface may be pre-treated with a coating. An adhesive, preferably a viscous adhesive with a viscosity of 20,000 mPa*s to 100,000 mPa*s, is preferably used for the coating. The pre-treatment coating fills small cracks, gaps or depressions in the side surface to create a smoother surface.

The first side surface of the second timber construction panel can also be pre-treated accordingly.

The coating of the first timber construction panel with adhesive and/or the arrangement of the second timber construction panel to the first timber construction panel can be automated. Automating these steps increases the efficiency of this method and therefore enables faster provision of the composite timber construction panels for their completion into a large-scale structure on site.

The first and second timber construction panels can be glued together at a first location to form a composite panel. The composite panel may be an intermediate product that may then be assembled at a second location to form a larger building structure, such as a floor ceiling. The first location may be an industrial production facility. The second location is preferably the place of use of the assembled larger building structure, it may for example be a construction site.

Preferably, the intermediate product is dimensioned in such a way that it can be transported from the first location to the second location using conventional trucks.

Two or more intermediate products may then be bonded together at the point of use. Preferably, two or more intermediate products are bonded together without applying pressure.

Preferably, the end product of this process is a statically load-bearing component for building structures, for example a statically load-bearing floor ceiling.

Statically load-bearing timber components can be used as structural load-bearing elements in buildings.

The term timber construction panel used herein means a structural element made of a timber-based material with two mutually parallel usable surfaces which, depending on their orientation, form a top side and a bottom side, and lateral surfaces which each have smaller dimensions than a usable surface. The two usable surfaces preferably have the same dimensions.

In a preferred embodiment, the timber panels take the form of a flat parallelepiped. The usable surfaces may take the form of a rectangular quadrilateral, for example a square. The timber panels are preferably cuboids. In a preferred embodiment, the timber panels have two usable surfaces and four lateral sides.

However, the panels may also have triangular usable surfaces or other polygonal usable surfaces. The number of lateral faces varies accordingly with the shape of the base surface.

The term timber-based material used herein means a material that is produced from joined, shredded timber, for example by gluing. Timber-based materials are, for example, cross-laminated timber, cross-ply timber, veneer plywood or glued laminated timber. Cross-laminated timber and cross-ply timber may both be referred to as cross-laminated timber or “CLT”. Timber-based materials in which the chopped timber structural elements are arranged crosswise to a similar extent are biaxially load-bearing.

However, single-axis load-bearing veneer plywood, for example LVL (Laminated Veneer Lumber) plywood, is not suitable as a timber panel for the method of the present invention. Although this timber component also has blocking layers, these are used exclusively for dimensional stability and not for force transmission in the direction of a second axis. For this reason, LVL veneer plywood panels are unsuitable for the method of the present invention.

A biaxial load-bearing timber construction panel is a component made of timber-based material that is load-bearing over its entire surface.

A “stable adhesive” is an adhesive with a viscosity of at least 20,000 mPa*s, or at least 25,000 mPa*s. Stable adhesives are usually structurally viscous non-Newtonian fluids whose viscosity changes with the shear rate. The required stability of an adhesive layer depends on its thickness. Thicker layers require a higher degree of stability.

A “viscous adhesive” is an adhesive with a viscosity of 15,000 mPa*s to 80,000 mPa*s, or 20,000 mPa*s to 50,000 mPa*s.

It is possible that an adhesive of a certain viscosity can be used as both a stable and a viscous adhesive.

### BRIEF DESCRIPTION OF THE FIGURES

The invention is explained in more detail with reference to the attached figures, which show

FIG. 1A a perspective view of the first side surfaces of an embodiment of the first timber construction panel coated with adhesive, with side surfaces of a first embodiment of the second timber construction panel shown above this view;

FIG. 1B a top view of the two adjacent timber panels shown in FIG. 1A;

FIG. 1C a sectional view A-A of the adjacent timber construction panels of FIG. 1B before they are brought together in an arrangement step;

FIG. 1D the sectional view A-A of FIG. 1C after the two timber panels have been arranged in relation to each other for bonding;

FIG. 2A a perspective view of the first side surfaces of one embodiment of the first timber construction panel coated with adhesive, withside surfaces of a second embodiment of the second timber construction panel shown above this view;

FIG. 2B a top view of the two adjacent timber panels shown in FIG. 2A;

FIG. 2C a sectional view A-A of the adjacent timber panels in FIG. 2B before they are brought together in an arrangement step;

FIG. 2D the sectional view A-A of FIG. 2C after the two timber panels have been arranged in relation to each other for bonding;

FIG. 3A a perspective view of the first side surfaces of one embodiment of the first timber construction panel coated with adhesive, withside surfaces of a third embodiment of the second timber construction panel showj above this view;

FIG. 3B a top view of the two adjacent timber panels shown in FIG. 3A;

FIG. 3C a sectional view A-A of the adjacent timber panels in FIG. 3B before they are brought together in an arrangement step;

FIG. 3D the sectional view A-A of FIG. 3C after the two timber construction panels have been arranged in relation to each other for bonding;

FIG. 4A a perspective view of the first side surfaces of one embodiment of the first timber construction panel coated with adhesive, with side surfaces of a fourth embodiment of the second timber construction panel shown above this view;

FIG. 4B a top view of the two adjacent timber panels shown in FIG. 4A;

FIG. 4C a sectional view A-A of the adjacent timber construction panels from FIG. 4B before they are brought together in an arrangement step;

FIG. 4D the sectional view A-A of FIG. 4C after the two timber panels have been arranged in relation to each other for bonding;

FIG. 5A a perspective view of the first side surfaces of one embodiment of the first timber construction panel coated with adhesive, with side surfaces of a fifth embodiment of the second timber construction panel show above this view;

FIG. 5B a top view of the two adjacent timber panels shown in FIG. 5A;

FIG. 5C a sectional view A-A of the adjacent timber construction panels from FIG. 5B before they are brought together in an arrangement step;

FIG. 5D the sectional view A-A of FIG. 5C after the two timber panels have been arranged in relation to each other for bonding;

Fig. a perspective view of the first side surfaces of one embodiment of the first timber construction panel coated with adhesive and, shown above, side surfaces of a sixth embodiment of the second timber construction panel;

FIG. 6B a top view of the two adjacent timber panels shown in FIG. 6A;

FIG. 6C a sectional view A-A of the adjacent timber construction panels from FIG. 6B before they are brought together in an arrangement step;

FIG. 6D the sectional view A-A of FIG. 6C after the two timber panels have been arranged in relation to each other for bonding;

### EMBODIMENTS OF THE INVENTION

Embodiments of the invention are illustrated by means of the Figures.

The timber construction panels shown in the figures are biaxial load-bearing panels made of timber-based material. The panels shown are cross-laminated timber panels made of several layers of timber, in which side faces of first layers of timber that intersect the main fiber direction of a first layer of timber alternate with side faces of adjacent layers of timber that run parallel to the main fiber direction of the adjacent layer of timber.

Depending on your requirements, the timber construction panels may have different dimensions suitable for use in construction.

In one embodiment, the timber panels have an area of 1 m² to 5 m², preferably 2 m² to 3 m², for example 2.5 m². However, timber panels with significantly larger dimensions may also be bonded using this method. For example, timber panels may also have an area of 10 m², 15 m² or 20 m².

The thickness of a timber construction panel may range from 5 cm to 50 cm, preferably from 10 cm to 30 cm, for example 20 cm.

The figures schematically show different embodiments of first and second timber construction panels, or combinations thereof, which can be bonded together to form a composite timber construction panel according to the method of the present invention. In all figures, the first timber construction panel 1 is shown below the second timber construction panel 2.

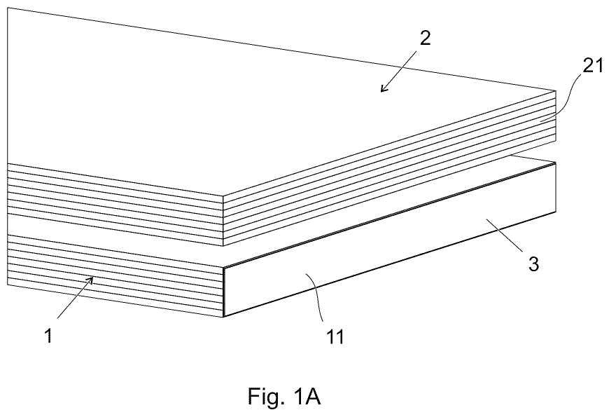

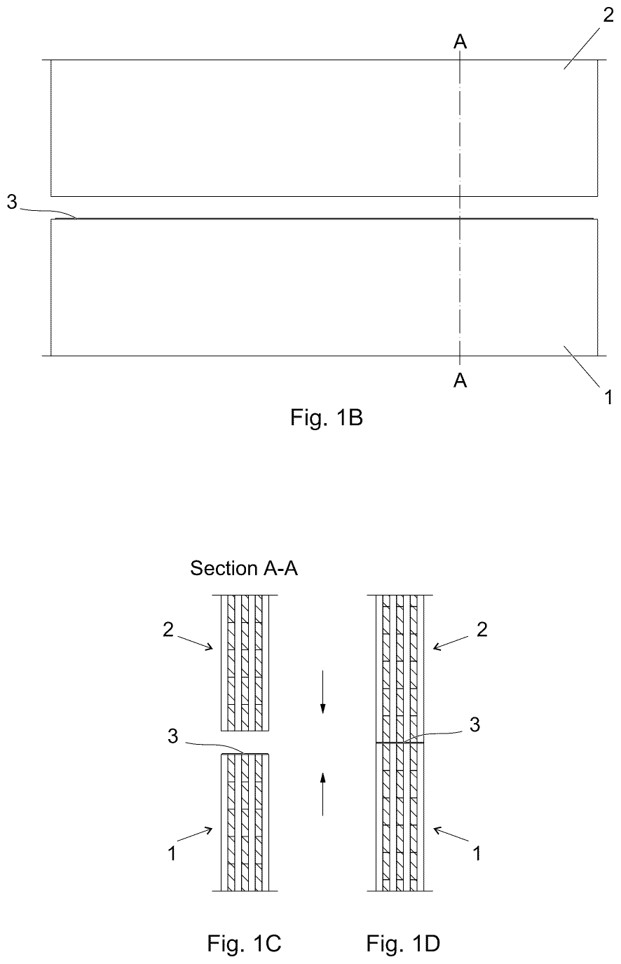

FIGS. 1A to 1D show a first, simple embodiment example in which both the first side surface 11 of the first timber construction panel 1 and the first side surface 21 of the second timber construction panel 2 are flat. The first side surface 11 of the first timber construction panel is coated with a stable adhesive 3. This is illustrated in the perspective view of FIG. 1A.

FIG. 1B is a top view of the first timber construction panel 1 and the second timber construction panel 2 of the first embodiment example, which are arranged longitudinally to one another so that the respective first side surfaces 11, 21 of the two timber construction panels 1, 2 are opposite one another. A-A indicates the sectional line that corresponds to the cross-sectional view in FIG. 1C.

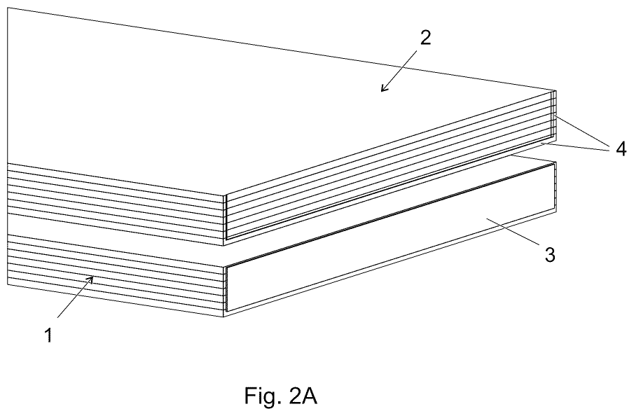

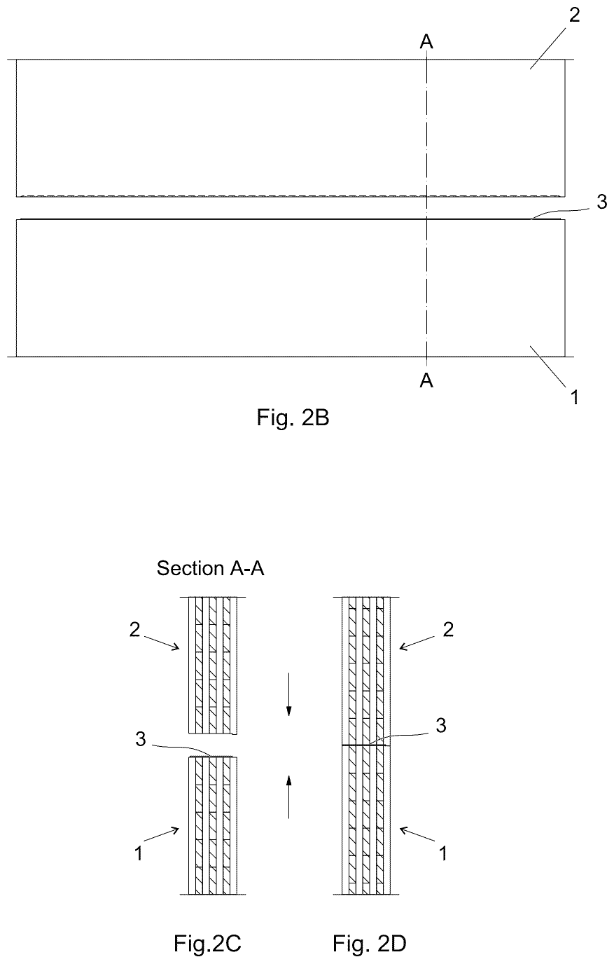

In FIGS. 1C and 1D, as well as in the corresponding FIGS. 2C, 2D, 3C, 3D, 4C, 4D, 5C, 5D 6C, and 6D, the side surfaces of the first timber layers that intersect the main fiber direction of a first timber layer are shown with diagonal stripes, while the side surfaces of the adjacent timber layers that run parallel to the main fiber direction of the respective timber layer are shown in white.

FIG. 1C shows a portion of a cross-sectional view A-A, in which the first side surface of the first timber construction panel 1, coated with adhesive 3, is opposite the first side surface of the second timber construction panel 2. The two panels are now pushed towards each other until they collide, which is indicated by the two arrows.

FIG. 1D shows the timber panels joined together with a connecting layer of adhesive. The adhesive layer completely fills the joint between the two timber panels 1,2. In this position, the stable adhesive hardens to form an adhesive layer.

During the curing of the adhesive according to the present invention, the two timber construction panels 1, 2 are not pressed against each other or moved further towards each other. The position of the two timber construction panels 1, 2, in particular the distance between the two timber construction panels, remains unchanged during the step of curing the adhesive. The adhesive is cured without exerting any pressing pressure.

FIG. 1D shows the connecting adhesive layer 3 between the two timber construction panels 1, 2, which now form a composite timbercomponent.

FIGS. 2A to 2D illustrate a second embodiment of timber construction panels which can be bonded together to form a composite timber component according to the present invention. The first side surface of the second timber construction panel has a spacer element 4 integral with the panel, which delimits the lower edge and the two lateral edges of the first side surface. The spacer element 4 defines a flat cavity that is open at the top. By joining with the adhesive 3 coated first side of the first timber construction panel, the shallow cavity is filled with adhesive so that an upwardly open joint filled with adhesive 3 is formed in the composite timber component. This is shown in FIGS. 2C and 2D. FIGS. 2A and 2B show the corresponding arrangements of this second embodiment example described in FIGS. 1A and 1B.

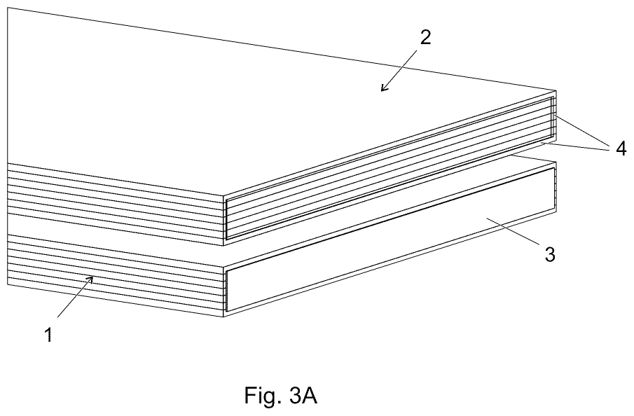

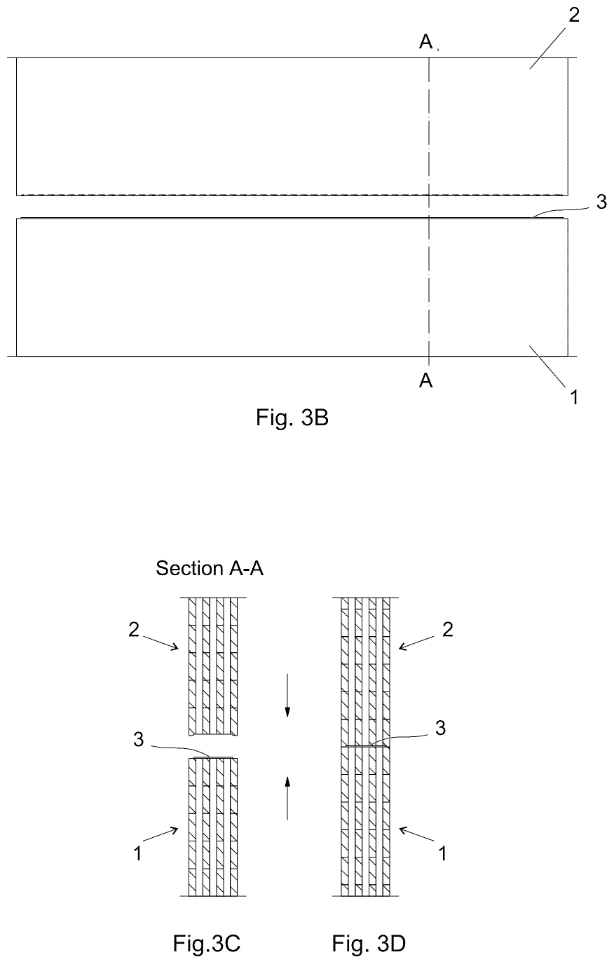

A third embodiment of timber construction panels that can be bonded according to the present invention is illustrated in FIGS. 3A to 3D.

In this embodiment example, as can be seen in FIG. 3A, the first side of the second timber construction panel 2 is completely surrounded by a spacer element 4. The spacer element 4 is formed in one piece with the second timber construction panel. The first side of the first timber construction panel 1 is coated with adhesive 3, the adhesive being applied over the entire surface in such a way that it can completely fill the shallow cavity enclosed by the spacer element 4, as shown in FIG. 3B.

When the two timber construction panels 1, 2 are now brought together, a closed joint filled with adhesive 3 is formed, as can be seen in FIGS. 3C and 3D.

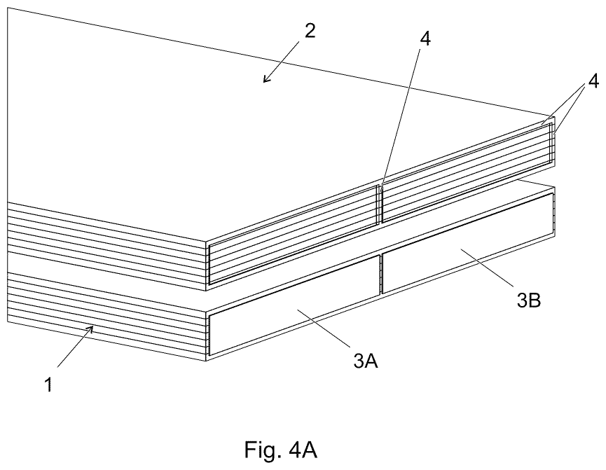

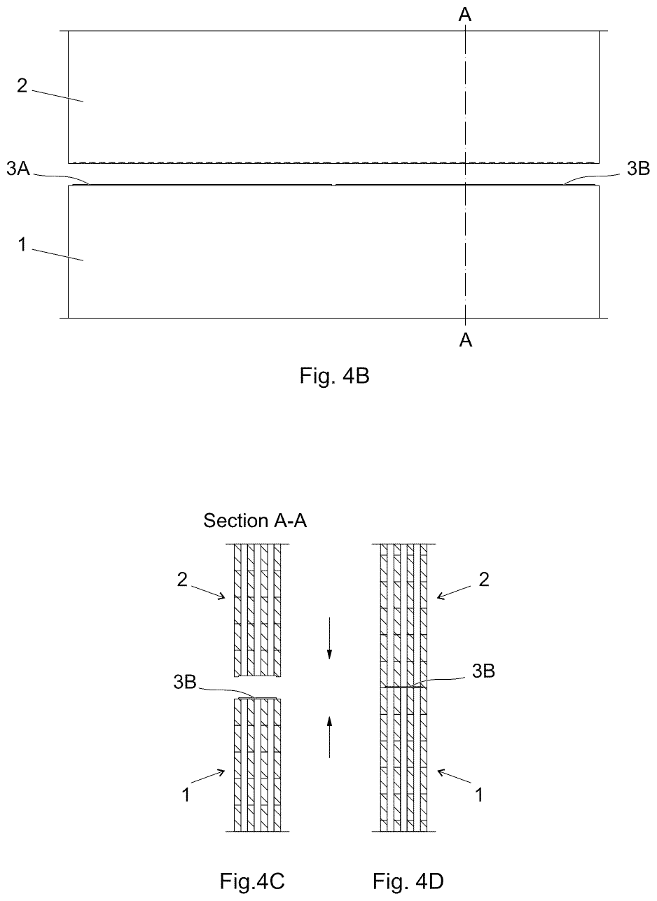

It is also possible to obtain composite timber components with multiple open or closed joint pockets using the method of the present invention. FIGS. 4A to 4D show, for example, a fourth possible embodiment of timber construction panels which can be bonded according to the present invention.

In this embodiment, the first side surface of the second timber construction panel 2 has a spacer element 4 that forms two closed, flat cavities that are arranged next to each other. The two areas of the first side surface of the first timber construction panel 1 are coated with adhesive 3A, 3B over the entire surface in accordance with the dimensions of the two cavities. However, it is also possible to provide a uniform adhesive coating. The joining of the panels during the arrangement causes the adhesive to swell out between the spacer 4 and its contact points on the first side surface of the first timber panel. If necessary, a thinner, remaining layer of adhesive may be applied to additionally bond the spacer to its contact surface.

As shown in FIGS. 4A, 4C and 4D, the two timber construction panels 1, 2 are arranged and bonded to each other according to the method of the present invention. The resulting composite timber component has two completely closed joint pockets, each of which is filled with a layer of adhesive 3.

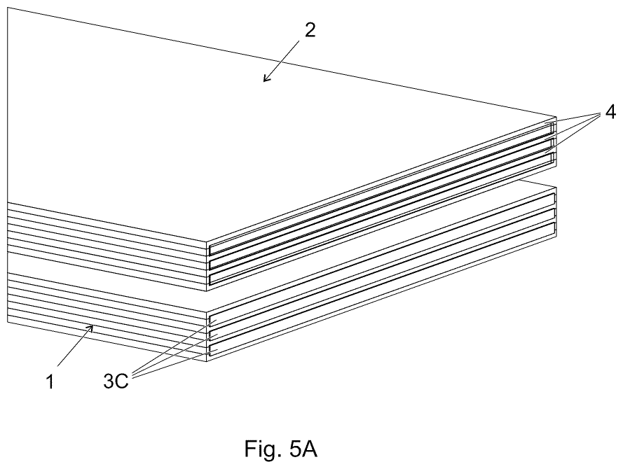

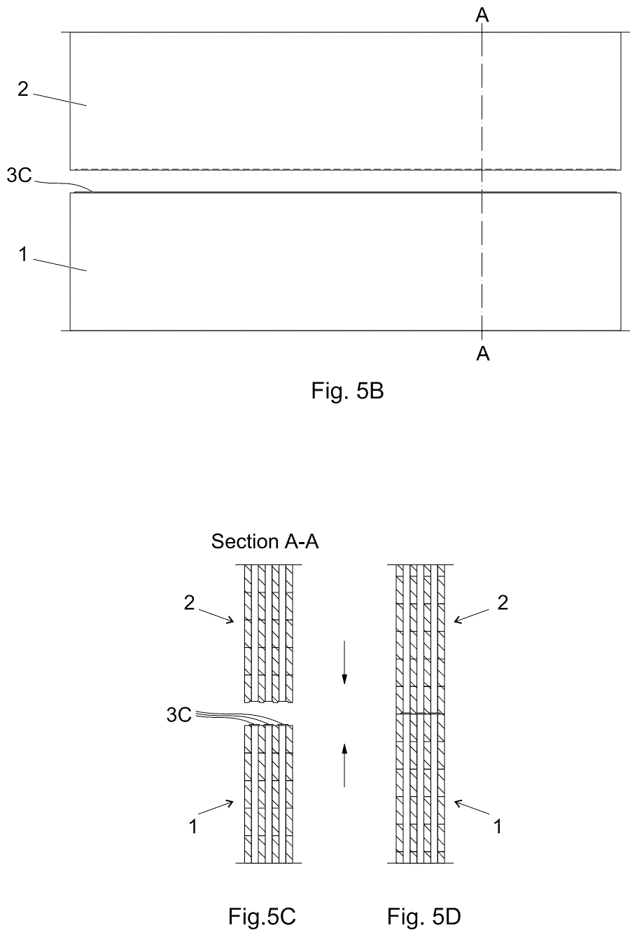

A further, fifth embodiment example of a first and second timber construction panel 1, 2, which can be bonded according to the present invention, is shown in FIGS. 5A to 5D.

As shown in FIG. 5A, the second timber construction panel 2 has a plurality of elongate flat cavities on its first side surface, which span the length of the side surface up to the spacer elements 4 and which are arranged next to one another. The spacer element 4 delimits these elongated cavities. The cavities are closed cavities for forming closed, elongated joints, which result from the arrangement and bonding steps shown in FIGS. 5B to 5D.

The first side surface of the first timber construction panel 1 can be coated with adhesive according to the dimensions of the flat, elongated cavities, as can be seen in FIG. 5A. However, in analogy to the fourth exemplary embodiment, it is also possible here to distribute the adhesive substantially over the entire first side surface of the first timber construction panel.

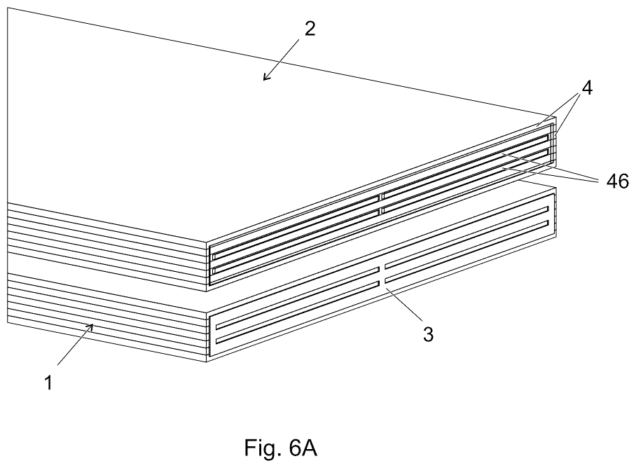

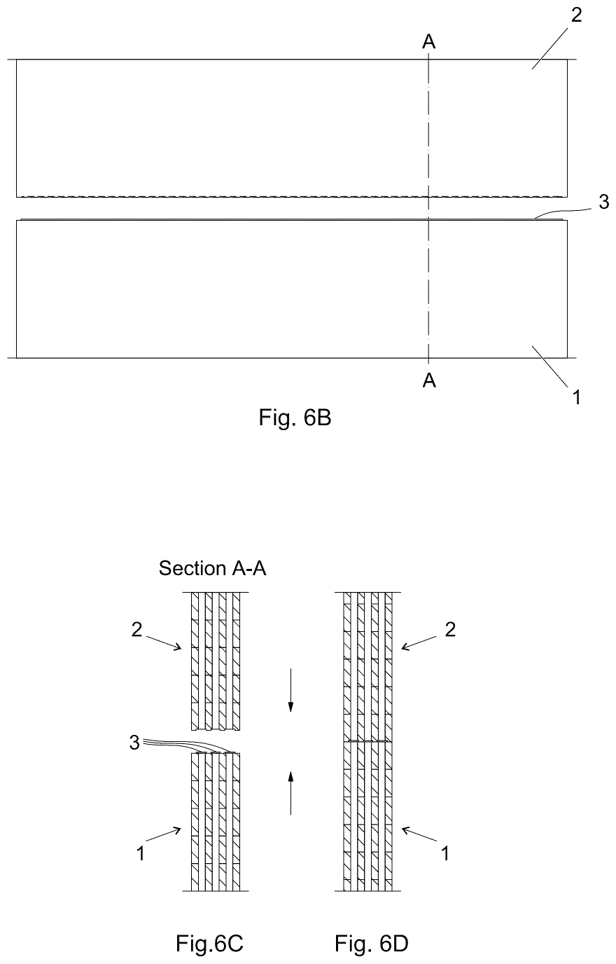

FIGS. 6A to 6D show a sixth possible embodiment of timber construction panels 1, 2 which can be bonded according to the present invention. As can be seen in FIG. 6A, a spacer element 4 arranged around the edge of the first side surface delimits a closed cavity of the second timber construction panel 2. The closed cavity can be subdivided by one or more further spacer elements 46 which do not contact the edge spacer element 4. In the illustrated embodiment, four spacer elements 46 arranged parallel to the surface of the second timber construction panel subdivide a closed, flat cavity. In the illustrated embodiment, the adhesive 3 is applied exclusively to the corresponding areas of the first side surface of the first timber construction panel 2.

By arranging and the joining of the panels as shown in FIGS. 6B to 6D, a closed joint is formed, which is divided into several portions by the central spacer elements 46.

The interruptions in the glued joints caused by central spacing serve primarily to absorb moisture-related swelling and shrinkage movements of the timber material. The bonded timber component is therefore less susceptible to changes in the level of moisture of the timber. The robustness of bonded timber components in different environmental conditions is therefore also improved.

Moreover, the arrangement of spacers centrally on the surface also allows to reduce the amount of adhesive used,, which is economically interesting, especially for bonding wider joints.

1. A method of making a composite timber construction panel for a building structure, comprising the steps of
(a) providing a first biaxial load-bearing timber construction panel with a first side surface,
(b) coating the first side surface of the first timber construction panel with a stable adhesive,
(c) arranging a second biaxially load-bearing timber construction panel (2) having a first side surface, so that the first side surface of the second timber construction panel abuts against the adhesive-coated first side surface of the first timber construction panel, thereby forming an adhesive layer covering the two first side surfaces,
(d) curing of the adhesive layer without applying pressure,
wherein the first side surface of the first timber construction panel and/or the first side surface of the second timber construction panel comprises at least one spacer element (4) which is arranged along at least a part of the periphery of the first side surface and which defines a shallow cavity.

2. The method according to claim 1, wherein the first side surface of the first timber construction panel is mechanically coated with the stable adhesive, for example by means of a slotted nozzle.

3. The method according to claim 1, wherein the at least one spacer element forms an integral part of the second timber construction panel.

4. The method according to claim 1, wherein one or more spacer elements are distributed over the area of the first side surface of the second timber construction panel.

5. The method according to claim 1, wherein one or more spacer elements delimit a plurality of open or closed shallow cavities.

6. The method according to claim 1, wherein the adhesive is a stable two-component adhesive or a stable multi-component adhesive.

7. The method according to claim 1, wherein the adhesive has a viscosity of 20,000 mPa*s to 100,000 mPa*s.

8. The method according to claim 1, wherein the two timber construction panels are arranged relative to each other such that a minimum distance of 0.1mm, 0.5mm, 1mm, 2mm, 3mm or 4mm is maintained between the first side surfaces of the timber construction panels during the curing of the adhesive

9. The method according to claim 1, wherein prior to step (a) a pre-treatment step comprising spackling of one or both first side surfaces to be bonded is carried out.

10. The method according to claim 1, wherein prior to step (a) a step of pretreating comprising coating the first side surface of the first timber construction panel with a base layer, for example a viscous adhesive layer, is carried out.

11. The method according to claim 1, wherein at least the steps of coating the first side surface of the first timber construction panel with adhesive and arranging the second timber construction panel relative to the first timber construction panel are automated.

12. A method of manufacturing a timber ceiling comprising
making a composite timber construction panel according to claim 1 at a first location,
transporting the composite timber construction panel to a second location,
joining two or more composite timber panels together to form a finished product at the second location.

13. The manufacturing method according to claim 12, wherein two or more composite timber construction panels are bonded together at the second location without applying pressure.

14. The manufacturing method according to claim 12, wherein the end product is used as a load-bearing floor ceiling or as a flat component of a load-bearing floor ceiling of a building.
